(19) United States
(12) Patent Application Publication
(10) Pub. No.: US 2015/0019731 A1
(43) Pub. Date: Jan. 15, 2015

(54) Fair Hierarchical Arbitration Of a Shared Resource With Varying Traffic Intensity

(71) Applicant: Dennis Abts, Eau Claire, WI (US)

(72) Inventor: Dennis Abts, Eau Claire, WI (US)

(73) Assignee: Google Inc., Mountain View, CA (US)

(21) Appl. No.: 13/453,677

(22) Filed: Apr. 23, 2012

(51) Int. Cl. G06F 15/173

(52) U.S. Cl. 709/226

(57) ABSTRACT

A method of arbitrating access to a shared resource that includes receiving requests from sources to access the shared resource. Each request has an associated traffic intensity of the respective source and an associated pendency of the request (e.g., age or waiting time). The method includes allocating access of the shared resource to each source in an order based on the associated traffic intensity and pendency of each request. The traffic intensity of a source may be the number of unacknowledged requests issued by that source at a time of generation of the associated request. The pendency of the request may be a difference between the generation time of the request and an arbitration cycle time.

### TECHNICAL FIELD

This disclosure relates to fair hierarchical arbitration of a shared resource.

### BACKGROUND

A multiple-processor system generally offers relatively high performance; because each processor can operate independently of the other processors in the system with no centralized processor closely controlling every step of each processor. If there were such centralized control, the speed of the system would be determined by the speed of the central processor and its failure would cripple the entire system. Moreover, parallel processing potentially offers an increase in speed equal to the number of processors.

In a multi-processor system, the processors typically share some resources. The shared resource may be memory or a peripheral I/O device. The memory may need to be shared because the processors likely act upon a common pool of data. Moreover, the memory sharing may be either of the physical memory locations or of the contents of memory. For instance, each processor may have local memory containing information relating to the system as a whole, such as the state of interconnections through a common cross-point switch. This information is duplicated in the local memory of each processor. When these local memories are to be updated together, the processors must agree among themselves which processor is to update the common information in all the local memories. The I/O devices are generally shared because of the complexity and expense associated with separate I/O devices attached to each of the processors. An even more fundamental shared resource is a bus connecting the processors to the shared resources as welt as to each other. Two processors may not simultaneously use the same bus except in the unlikely occurrence that each processor is simultaneously requiring input of the same information.

The combination of independently operating multi-processors and shared resources means that a request for a shared resource may occur at unpredictable times and two processors may simultaneously need the same shared resource. If more than one request is made or is outstanding at any time for a particular shared resource, conflict resolution must be provided which will select the request of one processor and refuse the request of the others.

### SUMMARY

One aspect of the disclosure provides a method of arbitrating access to a shared resource. The method includes receiving requests from sources to access the shared resource. Each request has an associated traffic intensity of the respective source and an associated pendency of the request (e.g., age or waiting time). The method includes allocating access of the shared resource to each source in an order based on the associated traffic intensity and pendency of each request. The traffic intensity of a source may be the number of unacknowledged requests issued by that source at a time of generation of the associated request. The pendency of the request may be a difference between the generation time of the request and an arbitration cycle time.

Implementations of the disclosure may include one or more of the following features. In some implementations, the method includes allocating access of the shared resource to each source in an order based on an urgency associated with one or more requests. For example, a request to access from memory and/or execute instructions for an operating system may have greater urgency than a request to access from memory and/or execute instructions for an application that executes within the operating system. The method may include allocating access of the shared resource to each source in an order based on a queue depth associated with each request. The queue depth equals the number of requests outstanding for the shared resource at the generation time of the request. The queue depth may serve as a proxy of the number of requests outstanding. Specific notations (i.e., incrementing a counter of ‘outstanding requests’ when one is generated, and decrementing the same counter when it is satisfied) may be used to track the number of pending requests.

The method may include allocating access of the shared resource to a first request having an associated first traffic intensity before a second request having an associated second traffic intensity, where the first traffic intensity is greater than the second traffic intensity. Moreover, the method may include allocating access of the shared resource to a first request having an associated first pendency before a second request having an associated second pendency, where the first pendency is greater than the second pendency.

In some implementations, the method includes allocating access of the shared resource to a first request having a first attribute value before a second request having an associated second attribute value, where the first attribute value differs from the second attribute in some material way consistent with a figure of merit (e., is greater than the second attribute value). Each attribute value may equal a sum of the traffic intensity and the pendency of the respective request. In some examples, the attribute value equals a sum of the traffic intensity, the pendency, and an urgency of the respective request. The urgency may have a numerical value. In additional examples, the attribute value equals a sum of the traffic intensity, the pendency, and a queue depth of the respective request. The queue depth equals the number of requests outstanding for the shared resource at the generation time of the request.

The method may include reading a packet header of each request. The packet header has attributes that include the traffic intensity and the pendency. Moreover, the method may include updating the traffic intensity and/or the pendency in the packet header of each unselected request after each arbitration cycle.

Another aspect of the disclosure provides an arbiter that includes a receiver and an allocator in communication with the receiver. The receiver receives requests from sources to access at least one shared resource. Each request has an associated traffic intensity of the respective source and an associated pendency of the request. The allocator allocates access of at least one shared resource to each source in an order based on the associated traffic intensity and pendency of each request. The traffic intensity of a source may be the number of unacknowledged requests issued by that source at a time of generation of the associated request. The pendency of the request may be a difference between the generation time of the request and an arbitration cycle time.

In some implementations, the allocator allocates access of the shared resource to each source in an order based on an urgency associated with one or more requests. The urgency may be a weighting, such as a number, evaluated by the allocator. Moreover, the allocator may allocate access of the shared resource to each source in an order based on a queue depth associated with each request. The queue depth equals the number of requests outstanding for the shared resource at the generation time of the request.

The allocator may allocate access of the shared resource to a first request having an associated first traffic intensity before a second request having an associated second traffic intensity, where the first traffic intensity is greater than the second traffic intensity. Similarly, the allocator may allocate access of the shared resource to a first request having an associated first pendency before a second request having an associated second pendency, where the first pendency is greater than the second pendency. Additionally, or alternatively, the allocator may allocate access of the shared resource to a first request having a first attribute value before a second request having an associated second attribute value, where the first attribute value is greater than the second attribute value. Each attribute value may equal a sum of the traffic intensity and the pendency of the respective request. In some examples, the attribute value equals a sum of the traffic intensity, the pendency, and an urgency of the respective request. The urgency may have a numerical value. In additional examples, the attribute value equals a sum of the traffic intensity, the pendency, and a queue depth of the respective request. The queue depth equals the number of requests outstanding for the shared resource at the generation time of the request.

In some implementations, the receiver reads a packet header of each request. The packet header has attributes that include the traffic intensity and the pendency. The receiver may update the pendency in the packet header of each unselected request after each arbitration cycle.

Yet another aspect of the disclosure provides a computer program product encoded on a computer readable storage medium including instructions that when executed by a data processing apparatus cause the data processing apparatus to perform operations. The operations include receiving requests from sources to access the shared resource. Each request has an associated traffic intensity of the respective source and an associated pendency of the request (e.g., age or waiting time). The operations include allocating access of the shared resource to each source in an order based on the associated traffic intensity and pendency of each request. The traffic intensity of a source may be the number of unacknowledged requests issued by that source at a time of generation of the associated request. The pendency of the request may be a difference between the generation time of the request and an arbitration cycle time.

In some implementations, the operations include allocating access of the shared resource to each source in an order based on an urgency associated with one or more requests. For example, a request to access from memory and/or execute instructions for an operating system may have greater urgency than a request to access from memory and/or execute instructions for an application that executes within the operating system. The operations may include allocating access of the shared resource to each source in an order based on a queue depth associated with each request. The queue depth equals the number of requests outstanding for the shared resource at the generation time of the request.

The operations may include allocating access of the shared resource to a first request having an associated first traffic intensity before a second request having an associated second traffic intensity, where the first traffic intensity is greater than the second traffic intensity. Moreover, the operations may include allocating access of the shared resource to a first request having an associated first pendency before a second request having an associated second pendency, where the first pendency is greater than the second pendency.

In some implementations, the operations include allocating access of the shared resource to a first request having a first attribute value before a second request having an associated second attribute value, where the first attribute value greater than the second attribute value. Each attribute value may equal a sum of the traffic intensity and the pendency of the respective request. In some examples, the attribute value equals a sum of the traffic intensity, the pendency, and an urgency of the respective request. The urgency may have a numerical value. In additional examples, the attribute value equals a sum of the traffic intensity, the pendency, and a queue depth of the respective request. The queue depth equals the number of requests outstanding for the shared resource at the generation time of the request.

The operations may include reading a packet header of each request. The packet header has attributes that include the traffic intensity and the pendency. Moreover, the operations may include updating the pendency in the packet header of each unselected request after each arbitration cycle.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary system having an arbitrator arbitrating access to a shared resource.

FIG. 2 is a schematic view of an exemplary multi-processor system having an arbitrator arbitrating access to shared memory.

FIG. 3 is a schematic view of an exemplary system having an arbitrator arbitrating access to a shared resource.

FIG. 4 provides an exemplary arrangement of operations for a method of arbitrating access to a shared resource.

FIG. 5 provides a schematic view of an exemplary network system with an exemplary request path and reply path.

Like reference symbols in the various drawings indicate like elements.

### DETAILED DESCRIPTION

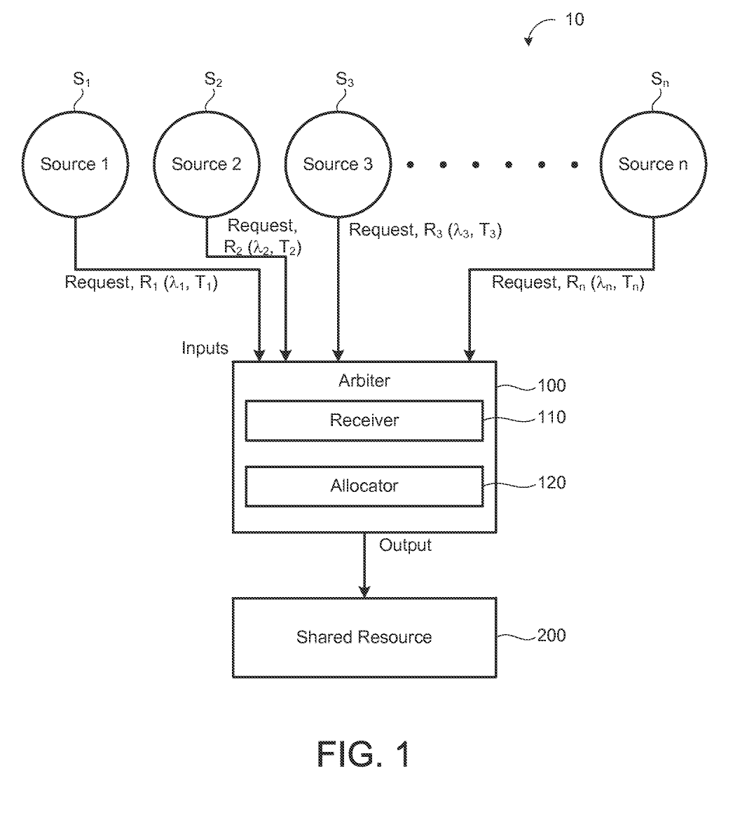

Referring to FIG. 1, in some implementations, a system 10 may use an arbiter 100 to allocate access to one or more resources 200 shared by multiple sources Sₙ (e.g., system components). In asynchronous circuits, the arbiter 100 may select the order of access to a shared resource 200 among asynchronous requests Rₙ from the sources Sₙ and prevent two operations from occurring at the same time when they should not. For example, in a computer having multiple computing processors (or other devices) accessing computer memory and more than one clock, requests R₁, R₂ from two unsynchronized sources S₁, S₂ (e.g., processors) may arrive at the shared resource 200 (e.g., memory) at nearly the same time. The arbiter 100 decides which request R₁, R₂ is serviced before the other.

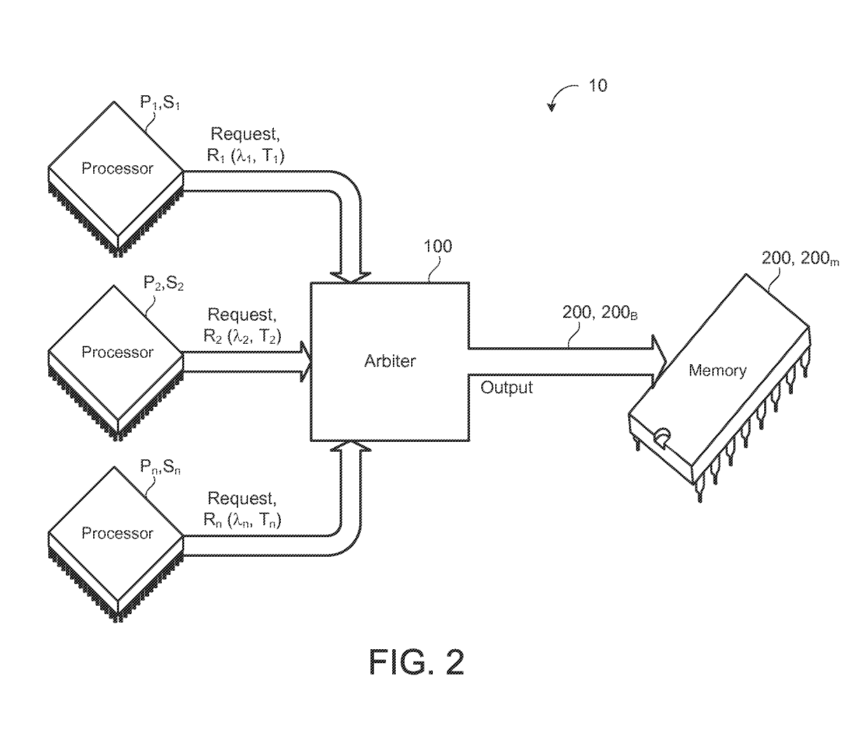

FIG. 2 illustrates an exemplary system 10, a multi-processor system, such as a multi-core processor, which may be a single computing component with two or more independent computing processors P₁, P₂, Pₙ (also referred to as “cores”) that read and execute program instructions. The computing processors P₁, P₂, Pₙ may share common resources 200, such as dynamic random-access memory 200ₘ (DRAM), a communication bus 200_{B} between the processors and the memory 200ₘ, and/or a network interface.

In general, an arbitration process creates a linearization among sources Sₙ (i.e., sharers or requesters) representing a partial ordering of “events” (e.g., memory requests or network requests) that can be deemed “locally fair” among the available sources Sₙ. Fair arbitration among sources Sₙ sharing common resources 200 allows efficient operation of the sources Sₙ.

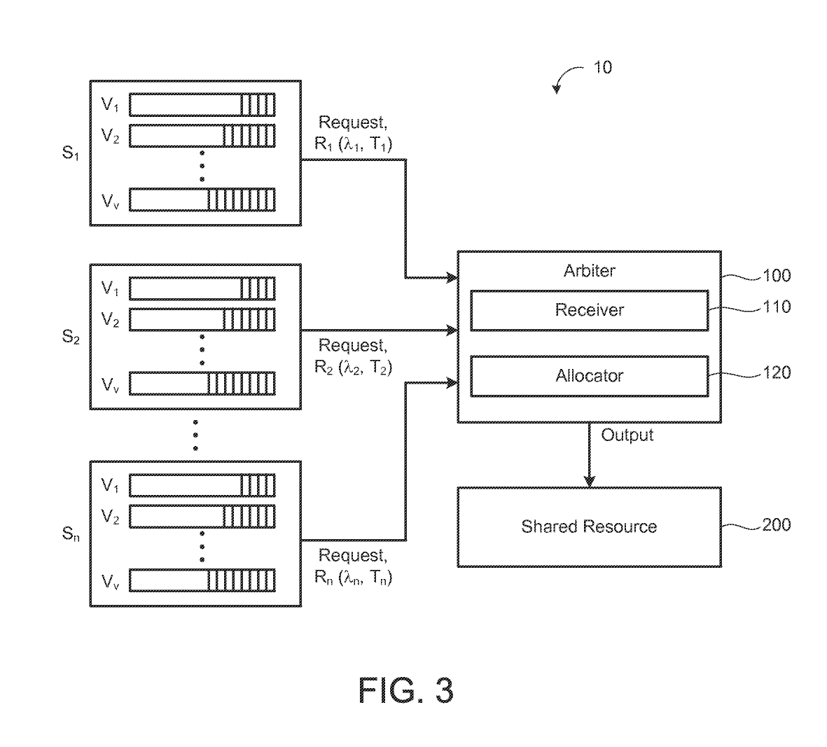

Referring again to FIG. 3, in some implementations, arbitration requests Rₙ may be divided into virtual buffers to provide performance isolation, quality of service (QoS) guarantees, and/or to segregate traffic for deadlock avoidance. Each request Rₙ from n sources Sₙ may be divided into v virtual inputs Vᵥ, each of which vies for a shared resource 200. An ordering or hierarchical arrangement of the requests Rₙ and virtual inputs Vᵥ allows for a multi-stage arbitration process. A first arbitration stage takes into account a traffic intensity λ from each source Sₙ by evaluating a “traffic load” attributed to arbitration request Rₙ. To make the selection process fair with respect to both space (bandwidth proportional to traffic intensity) and time (uniform response time), a second arbitration stage takes into account a temporal component representing the occupancy of an arbitration request Rₙ as a proxy for the age of the request Rₙ. Sources Sₙ (also referred to as requestors) that have been waiting will accumulate “age” which increases an arbitration priority relative to other virtual inputs Vᵥ from other sources Sₙ. The first and second arbitration stages provide “locally fair” selections at each stage.

The traffic intensity λ of a source Sₙ is the number of unacknowledged requests Rₙ from that source Sₙ in the system 10 at any given point in time. Since the traffic intensity λ fluctuates with time, for example as a result of bursty tragic, the traffic intensity λ represents the number of unacknowledged requests at the time a request Rₙ is generated (i.e. when a request packet is created in a load-store unit, or network interface).

An arbitration scheme may be considered “fair” if, for an equal offered load, each of the n sources Sₙ receive 1/n of the aggregate bandwidth of the shard resource 200. Moreover, the arbitration scheme may be locally fair by considering the traffic intensity λₙ emitted by each source Sₙ. The arbitration scheme may use the traffic intensity λₙ as a weight of a request Rₙ and perform a weighted, round-robin arbitration. This may not result a sharing pattern that is temporally fair, since the selection process is biased toward requests Rₙ emitted by “busier” sources (those with a higher traffic intensity λₙ).

Referring to FIGS. 1 and 3, in some implementations, an arbiter 100 includes a receiver 110 and an allocator 120 in communication with the receiver 110. The receiver 110 receives requests Rₙ from sources Sₙ (e.g., computing processors and/or network interfaces) to access at least one shared resource 200 (e.g., memory, communication channel, etc.). Each request Rₙ has an associated traffic intensity λₙ of the respective source Sₙ and an associated pendency Tₙ (i.e., waiting time) of the request Rₙ. The allocator 120 allocates access of the at least one shared resource 200 to each source Sₙ in an order based on the associated traffic intensity λₙ and pendency Tₙ of each request Rₙ. The traffic intensity λₙ of a source Sₙ may be the number of unacknowledged requests Rₙ issued by that source Sₙ at a time of generation of the associated request Rₙ. The pendency Tₙ of the request Rₙ may be a difference between the generation time of the request Rₙ and an arbitration cycle time, such as one or more processor clock counts.

In some examples, the allocator 120 allocates access of the shared resource 200 to a first request R₁ having an associated first traffic intensity λ₁ before a second request R₂ having an associated second traffic intensity λ₂, where the first traffic intensity λ₁ is greater than the second traffic intensity λ₂. Similarly, the allocator 120 may allocate access of the shared resource 200 to a first request R₁ having an associated first pendency T₁ before a second request R₂ having an associated second pendency T₂, where the first pendency T₁ is greater than the second pendency T₂.

In some implementations, the allocator 120 allocates access of the shared resource 200 to each source Sₙ in an order based on an urgency associated with one or more requests Rₙ. The urgency may be a weighting, such as a number, evaluated by the allocator 120. For example, a first request R₁ may have a first urgency less than a second urgency of a corresponding second request R₂. As s results, the allocator 120 may provide access to the shared resource 200 for the second request R₂ before the first request R₁. The second request R₂ may be for accessing and/or executing instructions of an operating system, white the first request R₁ may be for accessing and/or executing instructions of a software application that executes within the operating system.

The allocator 120 may allocate access of the shared resource 200 to each source Sₙ in an order based on a queue depth associated with each request Rₙ. The queue depth equals a number of requests Rₙ outstanding for the shared resource 200 at the generation time of the request Rₙ. The queue depth may serve as a proxy of the number of requests Rₙ outstanding. Specific notations (i.e., incrementing a counter of ‘outstanding requests’ when one is generated, and decrementing the same counter when it is satisfied) may be used to track the number of pending requests Rₙ.

Additionally, or alternatively, the allocator 120 may allocate access of the shared resource 200 to first request R₁ having a first attribute value before a second request R₁ having an associated second attribute value, where the first attribute value is greater than the second attribute value. Each attribute value may equal a sum of the traffic intensity λ and the pendency T of the respective request R. In some examples, the attribute value equals a sum of the traffic intensity λ, the pendency T, an urgency of the respective request, and/or a queue depth of the respective request R. The urgency may have a numerical and/or weighted value. The queue depth equals a number of requests Rₙ outstanding for the shared resource 200 at the generation time of the request R. In some implementations, the attribute value is expressed as a fraction of peak bandwidth, a value between 0 and 1, a time interval, or a value between 0 and a maximum number of requests Rₙ.

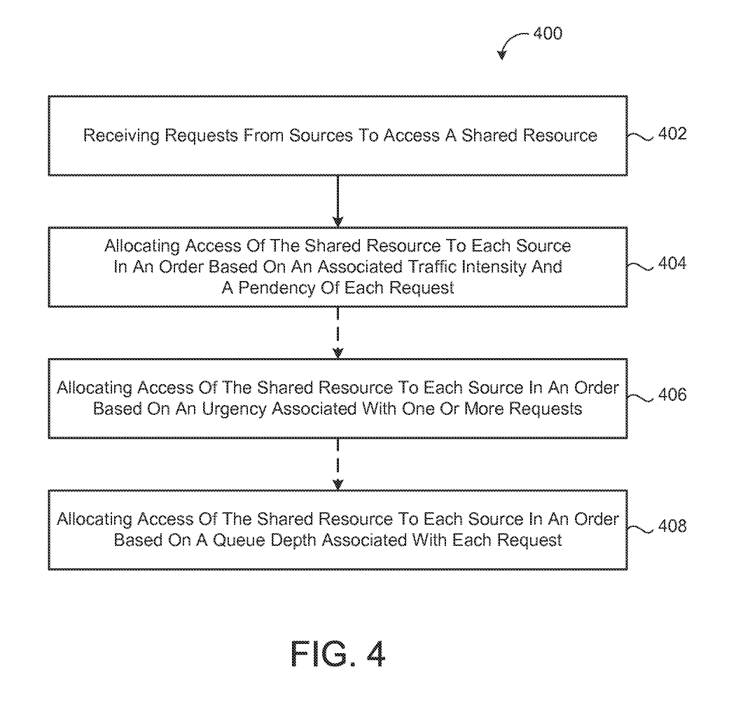

FIG. 4 provides an exemplary arrangement 400 of operations for a method of arbitrating access to a shared resource 200. The method includes receiving 402 requests Rₙ from sources Sₙ to access the shared resource 200. Each request Rₙ has an associated traffic intensity λₙ of the respective source Sₙ and an associated pendency Tₙ of the request Rₙ (e.g., age or waiting time). The method includes allocating 404 access of the shared resource 200 to each source Sₙ in an order based on the associated traffic intensity λₙ and pendency Tₙ of each request Rₙ. The traffic intensity λₙ of a source Sₙ may be the number of unacknowledged requests Rₙ issued by that source Sₙ at a time of generation of the associated request Rₙ. The pendency Tₙ of the request Rₙ may be a difference between the generation time of the request Rₙ and an arbitration cycle time.

In some implementations, the method includes allocating 406 access of the shared resource 200 to each source Sₙ in an order based on an urgency associated with one or more requests Rₙ. For example, a request Rₙ to access from memory and/or execute instructions for an operating system may have greater urgency than a request to access from memory and/or execute instructions for an application that executes within the operating system. The method may include allocating 408 access of the shared resource 200 to each source Sₙ an order based on a queue depth associated with each request Rₙ. The queue depth equals a number of requests Rₙ outstanding for the shared resource 200 at the generation time of the request Rₙ.

The method may include allocating access of the shared resource 200 to a first request R₁ having an associated first traffic intensity λ₁ before a second request R₂ having an associated second traffic intensity λ₂, where the first traffic intensity λ₁ is greater than the second traffic intensity λ₂. Moreover, the method may include allocating access of the shared resource 200 to a first request R₁ having an associated first pendency T₁ before a second request R₂ having an associated second pendency T₂, where the first pendency T₁ is greater than the second pendency T₂.

In some implementations, the method includes allocating access of the shared resource 200 to a first request R₁ having a first attribute value before a second request R₂ having an associated second attribute value, where the first attribute value greater than the second attribute value. Each attribute value may equal a sum of the traffic intensity λ₁, λ₂ and the pendency T₁, T₂ of the respective request R₁, R₂. In some examples, the attribute value equals a sum of the traffic intensity λ₁, λ₂, the pendency T₁, T₂, an urgency, and/or a queue depth of the respective request R₁, R₂. The queue depth equals a number of requests Rₙ outstanding for the shared resource 200 at the generation time of the request Rₙ.

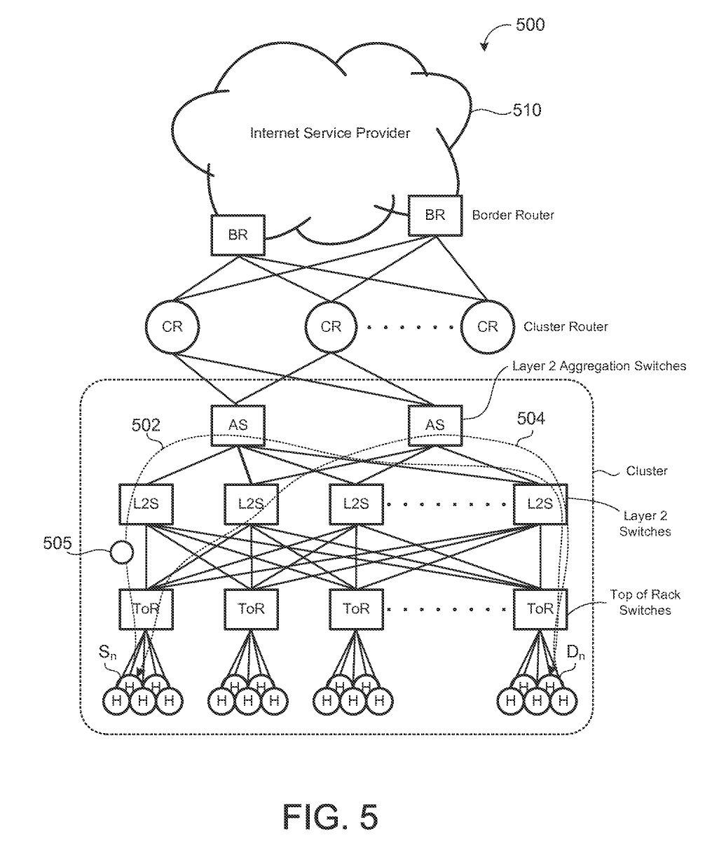

FIG. 5 provides a schematic view of an exemplary network system 500 with an exemplary request path 502 and reply path 504. The network system 500 includes an Internet service provider (ISP) 510 having one or more border routers BR in communication with one or more duster routers CR. At least one cluster router CR may communicate with one or more Layer 2 aggregation switches AS, which in turn communicate with one or more Layer 2 switches L2S. The Layer 2 switches L2S may communicate with top of rack switches ToR, which communicate with sources/destinations H, Sₙ, Dₙ.

Each processing element in the network system 500 may participate in a network-wide protocol where every request Rₙ (e.g., memory load) has a corresponding reply Pₙ (e.g., data payload reply). This bifurcates all messages in the network system 500 by decomposing all communication into two components: request Rₙ and reply Pₙ.

The source Sₙ of the request Rₙ may maintain a count N of the number of simultaneously outstanding requests Rₙ pending in the network system 500. The count N can be incremented for every newly created request Rₙ by a processing element and decremented for every reply Pₙ received. At the time the request Rₙ is made, the source Sₙ forms a message of one or more packets 505, each having a packet header that carries information about the message and for routing the packet from the source Sₙ to its destination Dₙ. A field within the packet header conveys the traffic intensity λ as λ=N (initial value when the request is initiated), where N is a current count of unacknowledged requests Rₙ. Since requests Rₙ are not necessarily uniform in size, a finer granularity of traffic intensity λ as a count M of the number of message flits (flow control units) currently in the network system 500.

Referring to FIGS. 1 and 5, in some implementations, the receiver 110 of the arbiter 100 reads a packet header of each request Rₙ. The packet header has attributes that include the traffic intensity λ and the pendency T. Whenever a packet 505 is queued by a system component for later retrieval and participation in an arbitration process, the packet 505 may be time stamped when received on the queue. The timestamp may be maintained as a free-running counter incremented on each clock cycle. When the packet 505 reaches the front of a queue, an occupancy time or pendency T is computed as the difference between a current time (now) and when the packet arrived (indicated by its timestamp) in the queue. The pendency T can be added to the traffic intensity λ as λ=λ+T. If the newly traffic intensity λ causes an overflow due to limited storage size of the traffic intensity field in the packet header, the value of the traffic intensity λ saturates at the maximum value. Once the traffic intensity λ is updated to account for time accumulated waiting in the queue, the request Rₙ may participate in the selection process (i.e. can “bid” as a participating source in the arbitration process). The arbitration selection processes includes selecting the request Rₙ with the traffic intensity λ. In case of a tie, the winner may be randomly chosen from a set of sources Sₙ having equal traffic intensities λₙ. Alternatively or additionally, a separate round-robin pointer can be used to break ties deterministically.

The arbitration process may select at most one input that will be granted the output. The receiver 110 may update the pendency Tₙ in the packet header of each unselected request Rₙ after each arbitration cycle. For example, every unselected request Rₙ₋₁ may receive an updated pendency T as T=T+1. Moreover, in examples where the pendency T is added to the traffic intensity λ, the traffic intensity can be updated as λ=λ+1, representing the accumulation of time (measured in clock cycles) waiting at the front of the queue.

The arbitration scheme combines weighted round-robin with age-based arbitration in a way that provides starvation-free selection among an arbitrary set of inputs (e.g., requests Rₙ from sources Sₙ) of varying traffic intensity λ. The traffic intensity λ provides a connection between arbitration priority and offered load. Relating the traffic intensity λ to the number of outstanding, unacknowledged requests Rₙ in the network system 500 may smooth out transient load imbalance and temporarily provides preference to those sources Sₙ that are generating traffic but not getting serviced in a timely manner. The traffic intensity λ is relatively larger for a first source S₁ communicating with a distant destination D₁ than for a second sources S₂ communicating with nearby destination D₂, because the round-trip latency is larger and relatively more packets 505 are in-flight for the first source S₁. As a result, the arbiter 100 may grant the first source S₁ access to the output (to the shared resource 200) more often than the second source S₂.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a client, one or more aspects of the disclosure can be implemented on a computer having a display device, e.g., a CRT (cathode ray tube), LCD (liquid crystal display) monitor, or touch screen for displaying information to the client and optionally a keyboard and a pointing device, e.g., a mouse or a trackball, by which the client can provide input to the computer. Other kinds of devices can be used to provide interaction with a client as well; for example, feedback provided to the client can be any form of sensory feedback, e,g., visual feedback, auditory feedback, or tactile feedback; and input from the client can be received in any form, including acoustic, speech, or tactile input. In addition, a computer can interact with a client by sending documents to and receiving documents from a device that is used by the client; for example, by sending web pages to a web browser on a client's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical client interface or a Web browser through which a client can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., HTML page) to a client device (e.g., for purposes of displaying data to and receiving client input from a client interacting with the client device). Data generated at the client device (e.g., a result of the client interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

1. A method of arbitrating access to a shared resource, the method comprising:
receiving, at a data processing apparatus in communication with the shared resource, requests from sources to access the shared resource, each request having an associated traffic intensity of the respective source and an associated pendency, urgency, and queue depth; and
allocating access of the shared resource, using the data processing apparatus, to each source in an order based on the associated traffic intensity, pendency, urgency, and queue depth of each request;
wherein the traffic intensity of a source comprises the number of unacknowledged requests issued by that source at a time of generation of the associated request;
wherein the pendency of the request comprises a difference between the generation time of the request and an arbitration cycle time;
wherein the urgency is based on a source type of the source; and
wherein the queue depth equals a number of requests outstanding for the shared resource at the generation time of the request.

2-3. (canceled)

4. The method of claim 1, further comprising allocating access of the shared resource to a first request having an associated first traffic intensity before a second request having an associated second traffic intensity, the first traffic intensity greater than the second traffic intensity.

5. The method of claim 1, further comprising allocating access of the shared resource to a first request having an associated first pendency before a second request having an associated second pendency, the first pendency greater than the second pendency.

6. The method of claim 1, further comprising allocating access of the shared resource to a first request having a first attribute value before a second request having an associated second attribute value, the first attribute value greater than the second attribute value, each attribute value equaling a sum of the traffic intensity and the pendency of the respective request.

7. The method of claim 6, wherein the attribute value equals a sum of the traffic intensity, the pendency, and an urgency of the respective request, the urgency having a numerical value.

8. The method of claim 6, wherein the attribute value equals a sum of the traffic intensity, the pendency, and a queue depth of the respective request, the queue depth equaling a number of requests outstanding for the shared resource at the generation time of the request.

9. The method of claim 1, further comprising reading a packet header of each request, the packet header having attributes comprising the traffic intensity and the pendency.

10. The method of claim 1, further comprising updating the pendency in the packet header of each unselected request after each arbitration cycle.

11. An arbiter comprising:
a receiver receiving requests from sources to access at least one shared resource, each request having an associated traffic intensity of the respective source and an associated pendency of the request; and
an allocator in communication with the receiver and allocating access of the at least one shared resource to each source in an order based on the associated traffic intensity, pendency, urgency, and queue depth of each request;
wherein the traffic intensity of a source comprises the number of unacknowledged requests issued by that source at a time of generation of the associated request; and
wherein the pendency of the request comprises a difference between the generation time of the request and an arbitration cycle time;
wherein the urgency is based on a source type of the source; and
wherein the queue depth equals a number of requests outstanding for the shared resource at the generation time of the request.

12-13. (canceled)

14. The arbiter of claim 11, wherein the allocator allocates access of the shared resource to a first request having an associated first traffic intensity before a second request having an associated second traffic intensity, the first traffic intensity greater than the second traffic intensity.

15. The arbiter of claim 11, wherein the allocator allocates access of the shared resource to a first request having an associated first pendency before a second request having an associated second pendency, the first pendency greater than the second pendency.

16. The arbiter of claim 11, wherein the allocator allocates access of the shared resource to a first request having a first attribute value before a second request having an associated second attribute value, the first attribute value greater than the second attribute value, each attribute value equaling a sum of the traffic intensity and the pendency of the respective request.

17. The arbiter of claim 16, wherein the attribute value equals a sum of the traffic intensity, the pendency, and an urgency of the respective request, the urgency having a numerical value.

18. The arbiter of claim 16, wherein the attribute value equals a sum of the traffic intensity, the pendency, and a queue depth of the respective request, the queue depth equaling a number of requests outstanding for the shared resource at the generation time of the request.

19. The arbiter of claim 11, wherein the receiver reads a packet header of each request, the packet header having attributes comprising the traffic intensity and the pendency.

20. The arbiter of claim 11, wherein the receiver updates the pendency in the packet header of each unselected request after each arbitration cycle.

21. A computer program product encoded on a non-transitory computer readable storage medium comprising instructions that when executed by a data processing apparatus cause the data processing apparatus to perform operations comprising:
receiving requests from sources to access the shared resource, each request having an associated traffic intensity of the respective source and an associated pendency of the request; and
allocating access of the shared resource to each source in an order based on the associated traffic intensity, pendency, urgency, and queue depth of each request;
wherein the traffic intensity of a source comprises the number of unacknowledged requests issued by that source at a time of generation of the associated request; and
wherein the pendency of the request comprises a difference between the generation time of the request and an arbitration cycle time;
wherein the urgency is based on a source type of the source; and
wherein the queue depth equals a number of requests outstanding for the shared resource at the generation time of the request.

22-23. (canceled)

24. The computer program product of claim 21, wherein the operations further comprises allocating access of the shared resource to a first request having an associated first traffic intensity before a second request having an associated second traffic intensity, the first traffic intensity greater than the second traffic intensity.

25. The computer program product of claim 21, wherein the operations further comprises allocating access of the shared resource to a first request having an associated first pendency before a second request having an associated second pendency, the first pendency greater than the second pendency.

26. The computer program product of claim 21, wherein the operations further comprises allocating access of the shared resource to a first request having a first attribute value before a second request having an associated second attribute value, the first attribute value greater than the second attribute value, each attribute value equaling a sum of the traffic intensity and the pendency of the respective request.

27. The computer program product of claim 26, wherein the attribute value equals a sum of the traffic intensity, the pendency, and an urgency of the respective request, the urgency having a numerical value.

28. The computer program product of claim 26, wherein the attribute value equals a sum of the traffic intensity, the pendency, and a queue depth of the respective request, the queue depth equaling a number of requests outstanding for the shared resource at the generation time of the request.

29. The computer program product of claim 21, wherein the operations further comprises reading a packet header of each request, the packet header having attributes comprising the traffic intensity and the pendency.

30. The computer program product of claim 21, wherein the operations further comprises updating the pendency in the packet header of each unselected request after each arbitration cycle.
